(19) United States
(12) Patent Application Publication
(10) Pub. No.: US 2025/0256249 A1
(43) Pub. Date: Aug. 14, 2025

(54) MULTIPHASE MIXING SYSTEM FOR HOMOGENOUS MIXING OF SOLID AND LIQUID COMPONENTS

(71) Applicant: Snowie LLC, Salt Lake City, UT (US)

(72) Inventor: Carl A. Rupp, Salt Lake City, UT (US)

(73) Assignee: Snowie LLC, Salt Lake City, UT (US)

(21) Appl. No.: 19/054,261

(22) Filed: Feb. 14, 2025

Related U.S. Application Data
(60) Provisional application No. 63/553,557, filed on Feb. 14, 2024.

(51) Int. Cl. B01F 25/53; B01F 21/00; B01F 21/20; B01F 25/433; B01F 35/00; B01F 35/71; B01F 101/06

(52) U.S. Cl. CPC B01F 25/53; B01F 21/20; B01F 21/30; B01F 25/4335; B01F 35/187; B01F 35/712; B01F 35/718051; B01F 2101/06

(57) ABSTRACT

Multiphase mixing systems and methods for creating homogenous mixtures of solid and liquid components. A system includes an inlet pump tube configured to be disposed within a mixing vessel. The system includes a pump in fluid communication with the inlet pump tube, wherein the pump extracts a solution from the mixing vessel when the inlet pump tube is disposed within the mixing vessel. The system includes a three-way valve in fluid communication with the pump. The system includes a differential pressure outlet configured to be disposed within the mixing vessel, wherein the differential pressure outlet is in fluid communication with the pump and the three-way valve. The system is such that the extracted solution is processed through the pump and ejected into the mixing vessel through the differential pressure outlet.

### CROSS-REFERENCE TO RELATED APPLICATIONS

This disclosure claims the benefit of U.S. Provisional Patent Application No. 63/553,557, filed Feb. 14, 2024, titled “MULTIPHASE MIXING SYSTEM FOR HOMOGENOUS MIXING OF SOLID AND LIQUID COMPONENTS,” which is incorporated herein by reference in its entirety, including but not limited to those portions that specifically appear hereinafter, the incorporation by reference being made with the following exception: In the event that any portion of the above-referenced provisional patent application is inconsistent with this disclosure, this disclosure supersedes the above-referenced provisional patent application.

### TECHNICAL FIELD

The disclosure relates generally to mixing fluids and more particularly to systems and methods for homogenous mixing of solid and liquid components.

### BACKGROUND

Frozen confectionaries such as snow cones and shaved ice are commonly combined with a flavoring syrup that is a mixture of sugar, water, flavoring, and other additives. In many cases, a provider of frozen confections may wish to prepare these flavoring syrups onsite rather than purchase premade flavoring syrups. When the flavoring syrups are purchased premade, the consumer may pay higher costs in shipping and storage. Additionally, the consumer has little or no ability to customize the flavoring syrups or control the freshness of the flavoring syrups. In these cases, the consumer may benefit from preparing the flavoring syrups onsite on an as-needed basis.

However, it can be difficult to prepare flavoring syrups for sale because the process requires preparing a homogenous mixture of large quantities of solid and liquid components. Traditional mixing methods may lead to incomplete dissolution, wherein solid sugar cannot fully dissolve within the water solvent. Consumers may have difficulty with mixing sugar in cold water due to limited molecular movement. Consumers may experience significant clumping of solid sugar components and may further experience settling wherein solid sugar components settle at the bottom of the water solvent rather than fully dissolving within the water solvent. The process may be time consuming, labor intensive, and messy.

What is needed are improved systems, methods, and devices for preparing a homogenous mixture of solid and liquid components, and specifically for preparing a homogenous mixture of sugar and water. In view of the foregoing, described herein are systems, methods, and devices for multiphase mixing to prepare homogenous solutions comprising a solid component dissolved within a liquid solvent.

### BRIEF DESCRIPTIONS OF THE DRAWINGS

Non-limiting and non-exhaustive implementations of the disclosure are described with reference to the following figures, wherein like reference numerals refer to like parts throughout the various views unless otherwise specified. Advantages of the disclosure will become better understood with regard to the following description and accompanying drawings where:

FIG. 1 is a schematic block diagram of a system for multiphase mixing of solid and liquid components, and further for solvent capture and processing;

FIG. 2 is a schematic illustration of a solution preparation system including a pump system and a solvent system for multiphase mixing of solid and liquid components, and further for solvent capture and processing;

FIG. 3 is a schematic illustration of a system for multiphase mixing of solid and liquid components, and further for solvent capture and processing;

FIG. 4A is a schematic illustration of a mixing process for mixing and churning the mixing fluids disposed within a mixing vessel according to the principles and teachings of the disclosure;

FIG. 4B is a schematic illustration of a mixing process for mixing and churning the mixing fluids disposed within a mixing vessel according to the principles and teachings of the disclosure;

FIG. 5 is a schematic illustration of a pump system for multiphase mixing of solid and liquid components, wherein a solvent is received from a pressurized water source;

FIG. 6A is a schematic illustration of a straight-on side view of a differential pressure nozzle;

FIG. 6B is a schematic illustration of a cross-sectional straight-on side view of a differential pressure nozzle;

FIG. 7 is a schematic illustration of a straight-on side view of a system for preparing and dispensing frozen confections; and

FIG. 8 is a schematic flow chart diagram of a method for mixing a composition according to the principles and teachings of the disclosure.

### DETAILED DESCRIPTION

Described herein are systems, methods, and devices for multiphase mixing to prepare a homogenous solution comprising solid components dissolved within a liquid solvent. The systems, methods, and devices described herein may specifically be utilized to dissolve relatively high quantities of sugar in a water solvent. The resultant sugar-water solution may be mixed with additional additives to create a flavored syrup for use with frozen confections such as snow cones or shaved ice.

Specifically disclosed herein are systems, methods, and devices, for mixing a liquid component and a solid component within a mixing vessel. A method includes preparing a mixing composition including a liquid solvent and a solid solute, wherein the mixing composition is disposed within a mixing vessel. The method includes submerging at least a portion of a first tube in the mixing composition and disposing at least a portion of a second tube within the mixing vessel, wherein the first tube and the second tube are in fluid communication with a pump. The method includes actuating the pump to generate a vacuum in the first tube such that at least a portion of the mixing composition is extracted from the mixing vessel through the first tube. The method includes mixing the mixing composition with a pressurized jet stream output through the second tube, wherein a differential pressure nozzle is attached to a distal end of the second tube.

In the following description of the disclosure, reference is made to the accompanying drawings, which form a part hereof, and in which is shown by way of illustration specific implementations in which the disclosure may be practiced. It is understood that other implementations may be utilized, and structural changes may be made without departing from the scope of the disclosure.

Before the methods, systems, and devices of the disclosure are disclosed and described, it is to be understood that this disclosure is not limited to the particular configurations, process steps, and materials disclosed herein as such configurations, process steps, and materials may vary somewhat. It is also to be understood that the terminology employed herein is used for the purpose of describing particular implementations only and is not intended to be limiting since the scope of the disclosure will be limited only by the appended claims and equivalents thereof.

In describing and claiming the disclosure, the following terminology will be used in accordance with the definitions set out below.

It must be noted that, as used in this specification and the appended claims, the singular forms “a,” “an,” and “the” include plural referents unless the context clearly dictates otherwise.

As used herein, the terms “comprising,” “including,” “containing,” “characterized by,” and grammatical equivalents thereof are inclusive or open-ended terms that do not exclude additional, unrecited elements or method steps.

As used herein, the phrase “consisting of” and grammatical equivalents thereof exclude any element, step, or ingredient not specified in the claim.

As used herein, the phrase “consisting essentially of” and grammatical equivalents thereof limit the scope of a claim to the specified materials or steps and those that do not materially affect the basic and novel characteristic or characteristics of the claimed disclosure.

As used herein, the terms “shaved ice” and/or “snow cone” refer broadly to the large family of ice-based desserts or confections made from the fine shavings of ice or finely crushed ice. It will be appreciated that shaved ice and/or snow cones may often include a flavoring that may be a syrup or other sweetened condiment that is added to the shaved ice or snow cone. Similarly, the terms “ice shaving” or “snow cone” in reference to a machine are intended broadly to include all machines used to make or produce the large family of ice-based desserts or confections that may be classified as shaved ice or snow cone products.

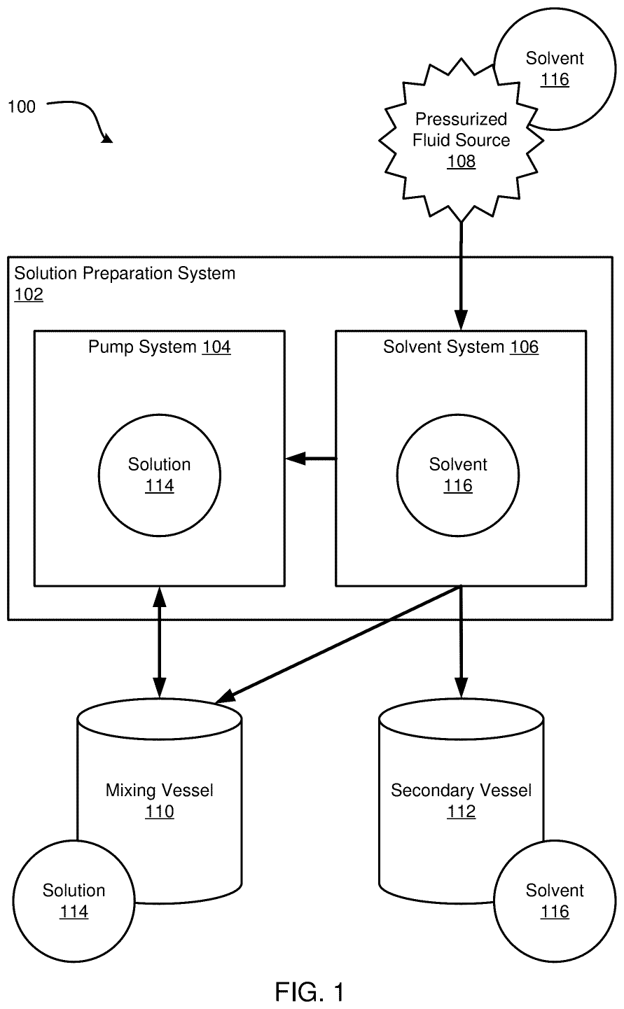

Referring now to the figures, FIG. 1 is a schematic block diagram of a system 100 for multiphase mixing and solvent capture. The system 100 is configured to efficiently agitate a solution to dissolve a solid solute within a liquid solvent. The system 100 may specifically be utilized to efficiently dissolve sugar in a water solvent. The system 100 may be equipped with only food-grade components, such that the resultant solution may be provided to users for consumption.

The system 100 includes a solution preparation system 102, which includes at least a pump system 104 and a solvent system 106. The solvent system 106 may receive a solvent 116 from a pressurized fluid source 108. The solution preparation system 102 includes a three-way valve to permit the solvent system 106 to provide the solvent 116 to the pump system 104. The solvent system 106 may further deposit the solvent 116 in a secondary vessel 112. The pump system 104 agitates and mixes a solution 114 within a mixing vessel 110.

The solvent 116 may include any suitable liquid solvent and may specifically include water. The pressurized fluid source 108 may include one or more of a hose, faucet, reservoir, tap, bottle, or any other source dispensing a fluid under pressure. In some cases, the solvent 116 is water that is supplied from a fresh water source.

The solution 114 includes the solvent 116 and additionally includes one or more solid solutes. The solution 114 may additionally include one or more liquid or gaseous solutes. The solution 114 is disposed within the mixing vessel 110. The pump system 104 is configured to extract the solution 114 from the mixing vessel 110 and then eject the solution 114 back into the mixing vessel 110.

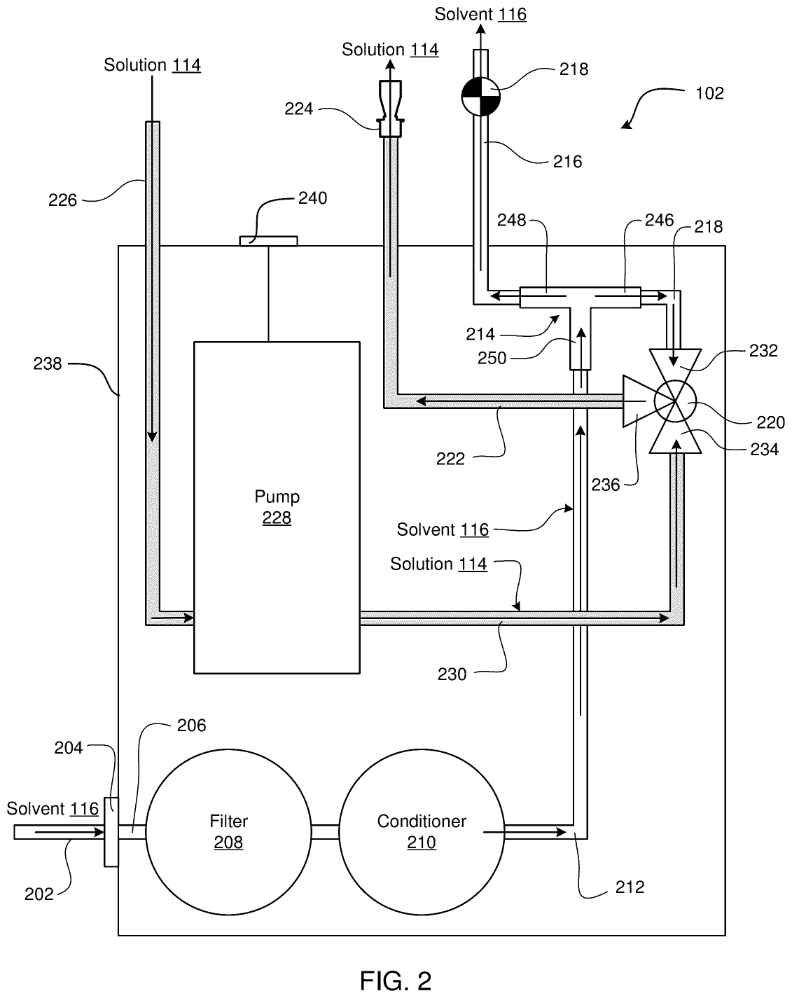

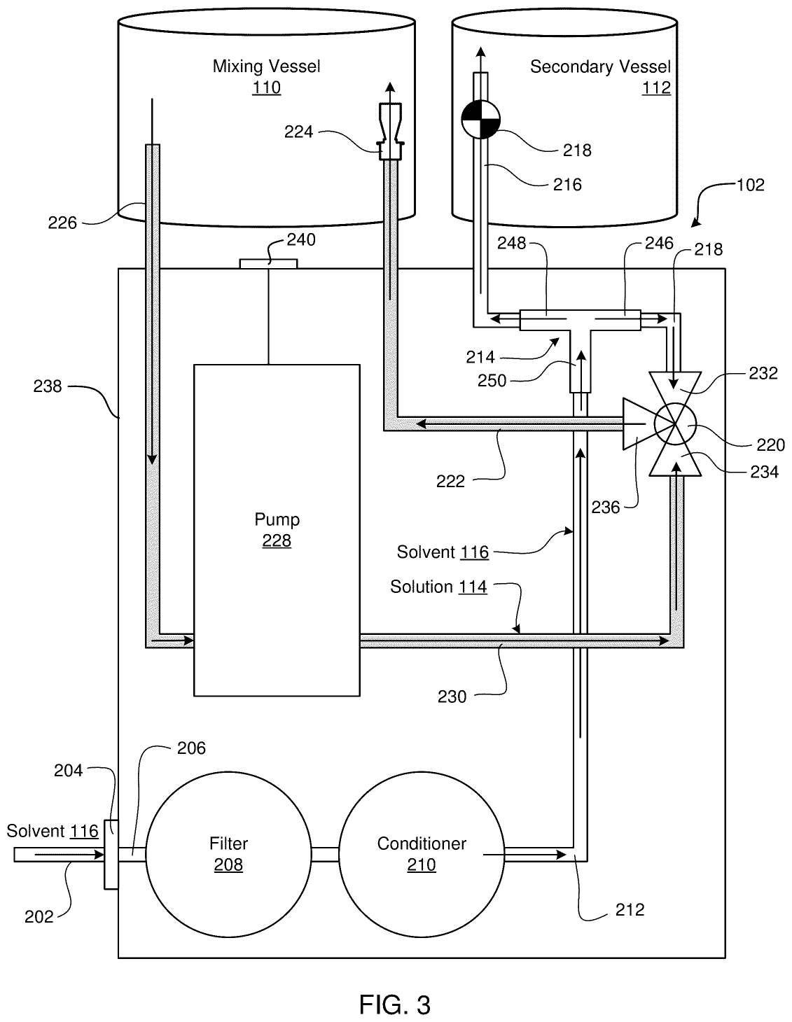

FIGS. 2 and 3 are schematic illustrations of components of the system 100 for multiphase mixing and solvent capture. FIG. 2 is a schematic illustration of the solution preparation system 102, including the pump system 104 and the solvent system 106. FIG. 3 is a schematic illustration of the system for multiphase mixing and solvent capture, including the solution preparation system 102, the mixing vessel 110, and the secondary vessel 112.

The solution preparation system 102 includes the solvent system (see 106 at FIG. 1). The solvent system 106 may include at least an inlet 204, filter 208, conditioner 210, filtered fluid tube 212, three-way junction 214, secondary output tube 216, valve 218, and a three-way valve 220.

The solution preparation system 102 includes the pump system (see 104 at FIG. 1). The pump system 104 may include at least an inlet pump tube 226, pump 226, outlet pump tube 230, three-way valve 220, differential pressure tube 222, and differential pressure nozzle 224. The three-way valve 220 provides a means for a solvent 116 from the solvent system 106 to enter components of the pump system 104, and thus, the three-way valve 220 may be considered a component of each of the solvent system 106 and the pump system 104.

The solvent system 106 is utilized to receive the solvent 116 from a pressurized fluid source (see 108 at FIG. 1) and process the solvent 116 with one or more of the filter 208 or the conditioner 210. The solvent system 106 additionally permits the solvent 116 to flow into one or more of the mixing vessel 110 or the secondary vessel 112 via the secondary output tube 216 and the valve 218. The solvent system 106 additionally permits the solvent 116 to flow into the mixing vessel 110 via the differential pressure tube 222 and differential pressure nozzle 224.

The pump system 104 extracts the solution 114 from the mixing vessel 110 and deposits the solution 114 back into the mixing vessel 110 via a differential pressure outlet, which comprises the differential pressure tube 222 and the differential pressure nozzle 224. The pump system 104 may receive the solvent 116 from the mixing vessel 110 and/or the solvent system 106 via the three-way valve 220.

The solvent system 106 includes the inlet 204, which provides a means to receive the solvent 116 from the pressurized fluid source 108. The solvent system 106 may additionally include an inlet tube 202 that feeds into the inlet 204. The inlet tube 202 may receive the solvent 116 from a pressurized fluid source and may specifically receive a water solvent from a pressurized freshwater source. In some cases, the inlet 204 is a threaded inlet configured to receive a standard hose. In these cases, the inlet 204 may include, for example, one-half inch threaded inlet, five-eighths inch threaded inlet, three-fourths inch threaded inlet, and so forth. The solvent 116 passes through the inlet tube 202 and inlet 204 and is then fed into the solvent 116 tube 206.

The solvent system 106 processes the solvent 116 through one or more of the filter 208 and the conditioner 210. The solvent processing systems disposed within the filter 208 and the conditioner 210 may include, for example, sediment filters, carbon filters, and so forth.

After the solvent 116 has passed through the filter 208 and the conditioner 210, the processed solvent is then fed into the filtered fluid tube 212. The filtered fluid tube 212 is downstream from the filter 208 and the conditioner 210. The filtered fluid tube 212 leads the filtered solvent 116 to a three-way junction 214. The three-way junction 214 includes a junction inlet 250 that receives the solvent 116 output by the pressurized fluid source 108. The three-way junction 214 includes a first junction outlet 246 that feeds the solvent 116 to the three-way valve 220, wherein the solvent 116 may then be permitted to exit through the differential pressure tube 222 and differential pressure nozzle 224. The three-way junction 214 includes a second junction outlet 248 that outputs the solvent 116 to the secondary output tube 216. If the valve 218 is open, then the solvent 116 may be permitted to exit the secondary output tube 216 where it may be deposited into one or more of the mixing vessel 110 or the secondary vessel 112. A user may open the valve 218 to allow the solvent 116 to pass through the secondary output tube 216 and into one or more of the mixing vessel 110 or the secondary vessel 112. The user may close the valve 218 to stop the flow of the solvent 116 through the secondary output tube 216.

The pump system 104 includes a pump 228 that creates a vacuum to extract the solution 114 from the mixing vessel 110. The pump 228 is in fluid communication with an inlet pump tube 226 that may be disposed within the mixing vessel 110. A user may press an actuator 240 to turn on the pump 228 and cause the pump to a create a vacuum, and this causes the solution 114 to be drawn up through the inlet pump tube 226 and into the pump 228. The solution 114 exits the pump 228 via the outlet pump tube 230.

The outlet pump tube 230 carries the solution 114 to the three-way valve 220, where the solution 114 enters the three-way valve 220 via a mixing pump valve port 234. If the three-way valve 220 is open, then the solution 114 passes through the three-way valve 220 and out via the output port 236 of the three-way valve 220. The solution 114 may then exit the pump system 104 by way of the differential pressure outlet, which comprises the differential pressure tube 222 and the differential pressure nozzle 224. The solution 114 may be ejected from the differential pressure nozzle 224 back into the mixing vessel 110.

The solution preparation system 102 includes a housing 238. The housing 238 may include rigid sidewalls disposed around the components of the solution preparation system 102, including each of the pump system 104 and the solvent system 106. The housing 238 may include one or more holes or channels cut through the sidewalls of the housing 238. These holes or channels may be utilized to feed tubing into the interior space of the housing 238 for storage. This ensure that the ends of tubing (see, e.g., the ends of 202, 226, 224, 216) are not exposed to outside contaminant when the solution preparation system 102 is not in use.

Each of the filter 208, conditioner 210, three-way valve 220, three-way junction 214, and pump 228 may be disposed within an interior space defined by sidewalls of the housing 238. Each of the inlet pump tube 226, differential pressure tube 222, and secondary output tube 216 may be partially disposed within the interior space defined by the housing 238 and partially disposed exterior to the housing 238. The housing 238 may include one or more holes for permitting the inlet pump tube 226, differential pressure tube 222, and secondary output tube 216 to exit the interior space defined by the housing 238.

The housing 238 may be a relatively small, portable box that is approximately the size of a briefcase. The housing 238 may include a handle (not shown) and can support an external actuator 240 for controlling the pump 228 and an external valve switch (not shown) for opening and closing the three-way valve 220. The housing 238 may also include a mechanism to reel in the tubing and secure the tubing during transport.

The solution preparation system 102 includes an actuator 240 in electrical communication with the pump 228. The actuator 240 includes a switch, button, or other means for turning the pump 228 on and off. When the pump 228 is turned on a by a user, the pump 228 will begin to create a vacuum within the inlet pump tube 226. If a portion of the inlet pump tube 226 is submerged within a fluid when the pump 228 is turned on, then the fluid will begin to be “sucked up” the inlet pump tube 226 due to the vacuum created by the pump 228. The pump 288 will further push the fluid into the outlet pump tube 230 and ultimately out through the differential pressure nozzle 224.

As illustrated in FIG. 3, the pump system 104 is configured to mix and churn the solution 114 disposed within the mixing vessel 110. The pump system 104 accomplishes this by sucking the solution 114 into the inlet pump tube 226 with the pump 228, and then pushing the solution 114 into the outlet pump tube 230 with the pump 228. The pump 228 further pushes the solution 114 through the three-way valve 220 by way of the pump valve port 234 and out through the outlet port 236. The solution 114 continues through the differential pressure tube 222 and the differential pressure nozzle 224. The solution 114 is then again taken up by the pump 228, and the process continues until the pump is turned off by a user.

Further as shown in FIG. 3, in some implementations, the solution preparation system 102 may be simultaneously used to mix the contents of the mixing vessel 110 and also fill a secondary vessel 112 with solvent 116. In this implementation, the solution 114 within the mixing vessel 110 is mixed and churned by cycling the solution 114 through the pump 228 and the differential pressure nozzle 224 as previously disclosed. At the same time, fresh solvent 116 may pass through the inlet 204, the filter 208 and/or the conditioner 210, through the filtered fluid tube 212, through the three-way junction 214, through the secondary output tube 216, and through the valve 218 (i.e., if the valve 218 is in the open position).

When the pump 228 is turned on, and when the ends of the inlet pump tube 226 and differential pressure tube 222 are disposed within the mixing vessel 110, the solution preparation system 102 creates a “stir circuit” within the mixing vessel 110. The stir circuit is utilized to stir, mix, and churn the solution 114 disposed within the mixing vessel 110. The stir circuit causes the solution 114 to be comprehensively mixed due to the movement of fluid within the mixing vessel 110. The liquid jet stream output through the differential pressure nozzle 224 is sufficiently strong to reach the corners of the mixing vessel 110 where the certain contents may be most difficult to mix. By contrast to other methods, this method does not rely on any tool that may break, need cleaning, damage the mixing vessel 110, or spill. The liquid jet stream output through the differential pressure nozzle 224 becomes a tool that mixes the solution 114. Also, the device may be left running for the few minutes it takes to complete the mix, leaving the operator free for other tasks.

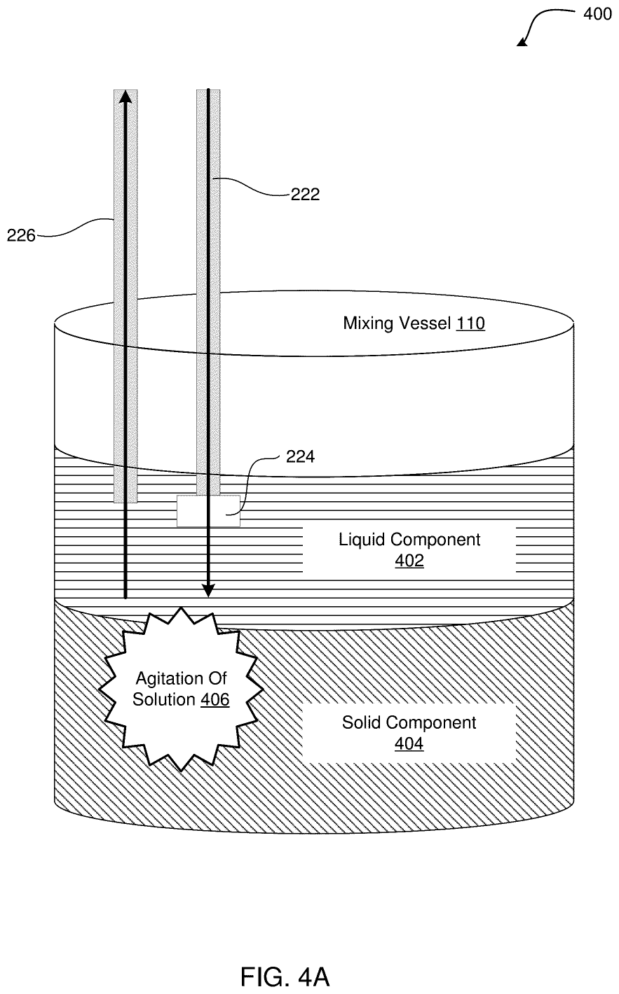

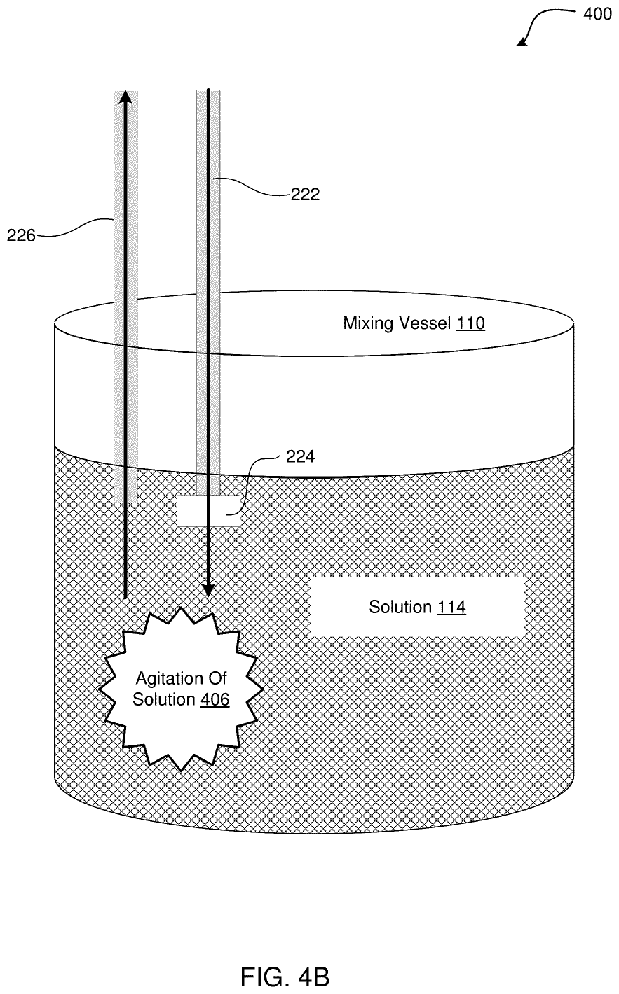

FIGS. 4A and 4B are schematic illustrations of a mixing process 400 for mixing and churning the mixing fluids disposed within the mixing vessel 110. FIG. 4A illustrates wherein mixing components are in their original form, and FIG. 4B illustrates a final dissolved solution.

As shown in FIG. 4A, the mixing vessel 110 may include at least a liquid component 402 and a solid component 404. It should be appreciated that the mixing vessel 110 may include any number of liquid components 402 and solid components 404 as deemed necessary by a user. The liquid component 402 may include the solvent 116 and may additionally include one or more other liquid components. In an exemplary use-case, the mixing vessel 110 includes a water solvent (i.e., a liquid component 402), a solid sugar solute (i.e., a solid component 404), a solid or liquid flavoring solute, and one or more solid or liquid preservative solutes. The contents of the mixing vessel 110 will vary depending on the intended use of the systems, methods, and devices described herein.

The mixing process 400 includes sucking up the mixing fluid (i.e., a mixture of the liquid component 402 and/or the solid component 404) through the inlet pump tube 226 due to the vacuum created by the pump 228. As discussed in connection with FIGS. 2-3, the pump 228 is responsible for extracting the mixing fluid from the mixing vessel 110. The mixing process 400 additionally includes pressurized ejection of the mixing fluid back into the mixing vessel 110 through the differential pressure tube 222 and differential pressure nozzle 224. This creates agitation of the solution 406, which reduces the time required to fully mix the liquid and solid components 402, 404 to generate the solution 114.

The solution preparation system 102 can therefore quickly, efficiently, and cleanly create a homogeneous mixture of water, sugar, and any other ingredient needed. An operator can use the following actions to create the homogeneous mixture. The operator puts sugar into the mixing vessel 110. In some embodiments the mixing vessel 110 is relatively large, such as a 10-gallon or 20-gallon container. The mixing vessel 110 may hold a large amount of sugar, such as an entire 25-pound bag. The mixing vessel 110 may be more than halfway full of the sugar. Additives, such as citric acid, flavoring, and/or preservatives can then be added to the mixing vessel 110. The mixing vessel 110 may include a spout that holds the inlet and outlet lines and preferably does not leave a large opening to prevent spillage, splatter, or drips.

The result of the mixing procedure is a homogeneous dissolved solution 114 disposed within the mixing vessel 110 as shown in FIG. 4B. By contrast to previous designs, the mixing procedure of the disclosure is capable of mixing substantial amounts of sugar, water, and additives in a relatively brief time. The mixing procedure of this disclosure is also much less resource intensive and less prone to mess and loss due to spillage. In the business of selling confectioneries such as frozen confectioneries, the speed at which each customer is served is a limiting factor for the amount of money that can be earned with such a device. The time saved due to the water dispensing and sugar mixing devices of the disclosure result in an immediate cost and time savings. Furthermore, the devices allow for a custom mix to be made, and the flavor mixture can be mixed on site without requiring the shop to close while more flavoring is obtained from a store, a warehouse, or the like. The time savings are particularly important at large events such as sporting events and festivals where there are large numbers of people who will line up to buy a refreshing frozen confectionery. The water dispensing and sugar mixing devices of the disclosure increase the amount of money that can be made at such establishments.

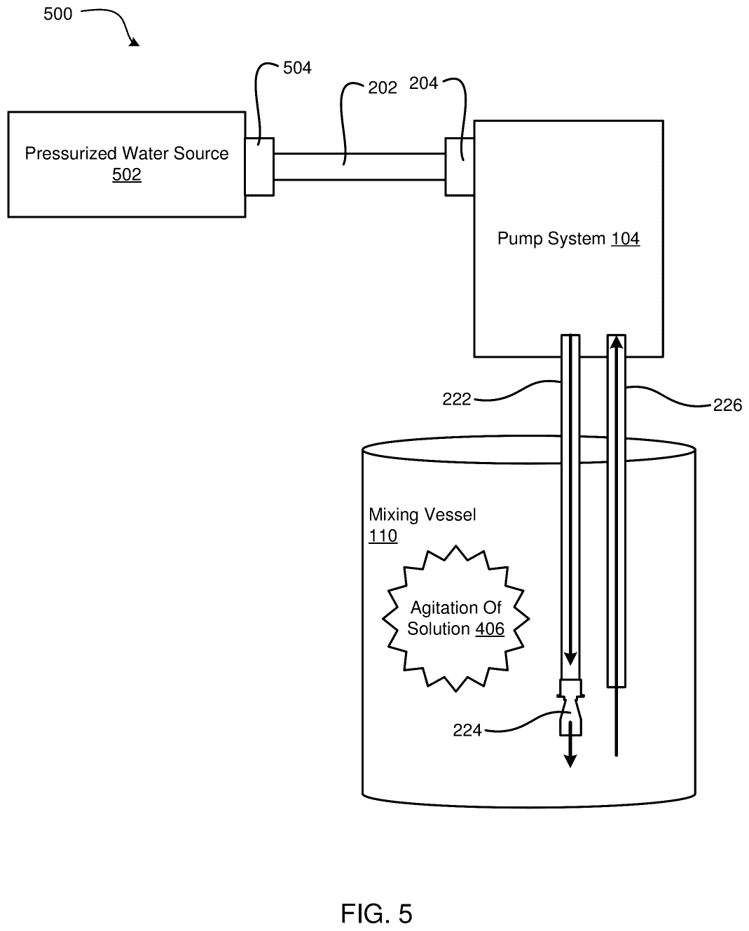

FIG. 5 is a schematic block diagram of a system 500 for multiphase mixing, and specifically a system 500 for homogenous mixing of solid and liquid components. The system 500 includes the pump system 104 and the mixing vessel 110. The system 500 additionally includes a pressurized water source 502 in fluid communication with the pump system 104. The pressurized water source 502 may comprise a valve 504 for releasing or blocking the flow of water from the pressurized water source. The inlet tube 202 of the solution preparation system 102 may directly connected to the pressurized water source 502 to receive water from the pressurized water source 502 and then feed the water 502 through components of the solution preparation system 102 (e.g., the filter 208 and conditioner 210) prior to depositing the water into the mixing vessel 110.

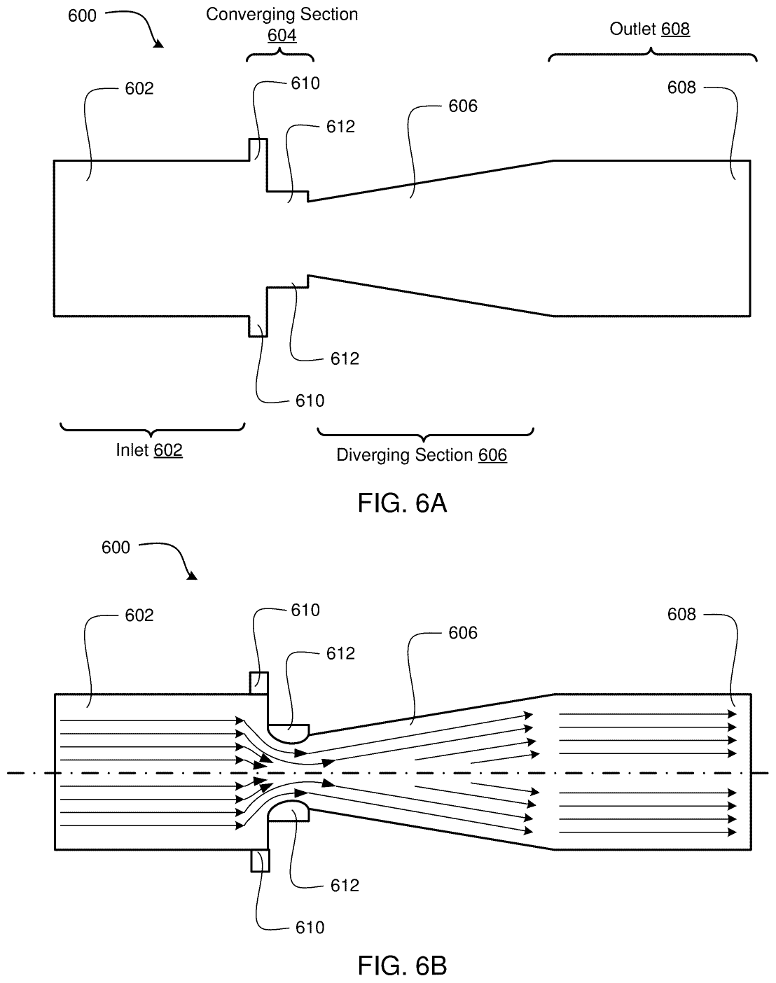

FIGS. 6A-6B are schematic illustrations of a nozzle 600. The nozzle 600 may specifically include a Venturi eductor or Venturi ejector. The nozzle 600 may serve as the differential pressure nozzle 224 of the differential pressure outlet of the pump system 104 as described herein. FIG. 6A is a schematic illustration of a straight-on side view of the nozzle 600. FIG. 6B is a schematic illustration of a cross-sectional straight-on side view of the nozzle 600.

The nozzle 600 includes an inlet 602 comprising an inlet fluid passageway for receiving a fluid, wherein the inlet fluid passageway comprises an inlet diameter. The nozzle 600 includes an outlet 608 comprising an outlet fluid passageway for ejecting a fluid, wherein the outlet fluid passageway comprises an outlet diameter. The inlet 602 is disposed at a proximal end of the nozzle 600 (i.e., the end attached to the differential pressure tube 222). The outlet 608 is disposed at the distal end of the nozzle 600.

The nozzle 600 comprises a converging section 604 and a diverging section 606. The converging section 604 comprises a high pressure tap 610 and a low pressure tap 612. The converging section 604 includes a narrowing fluid passageway. The narrowest portion of the narrowing fluid passageway may be referred to as the narrow diameter.

The diverging section 606 is disposed in between the converging section 604 and the outlet 608. The diverging section 606 comprises a widening fluid passageway comprising a plurality of diameters, wherein the narrowest diameter of the widening fluid passageway is disposed adjacent to the converging section 610, and the widest diameter of the widening fluid passageway is disposed adjacent to the outlet 606.

The narrow diameter of the converging section 604 is smaller than the inlet diameter of the inlet 602. The narrow diameter of the converging section 604 is also smaller than the outlet diameter of the outlet 608.

Fluid flows through the nozzle 600 as shown in the cross-sectional view of FIG. 6B. The nozzle 600 works based on the Venturi effect, which states that when a fluid flows through a constricted section of a pipe (i.e., the converging section 604), the velocity of the fluid will increase while the pressure of the fluid will decrease. Fluid passes into the converging section 604 at the low pressure tap 610 which causes the fluid to speed up due to conservation of mass. The fluid passes into the narrowest point where it reaches its highest velocity and lowest pressure, which can create suction. The fluid passes into the diverging section 606 where the passage widens again, which slows down the fluid and restores pressure.

The differential pressure nozzle 224, which may specifically include the nozzle 600 as described in connection with FIGS. 6A-6B, enables the pump 228 to take advantage of surrounding mixing fluid within the mixing vessel 110 to generate a high-velocity flow yield. The differential pressure nozzle 224 takes advantage of the Venturi effect, which occurs when a fluid flows through a converging-diverging section. A motive stream of the mixing fluid enters the differential pressure nozzle 224 and accelerates as the mixing fluid passes through the narrowing section of the differential pressure nozzle 224. Thus, a velocity of the mixing fluid increases significantly at the throat of the differential pressure nozzle 224. According to the principle of conservation of mass, the high-velocity flow creates a region of low static pressure. Consequently, a pressure difference arises between the mixing fluid at the throat of the differential pressure nozzle 224, and the surrounding mixing fluid disposed within the mixing vessel 110.

The differential pressure nozzle 224 may include any differential pressure nozzle 224 known in the art, and need not include the same geometry, dimensions, or configuration as the exemplary differential pressure nozzle 224 illustrated in FIGS. 6A-6B.

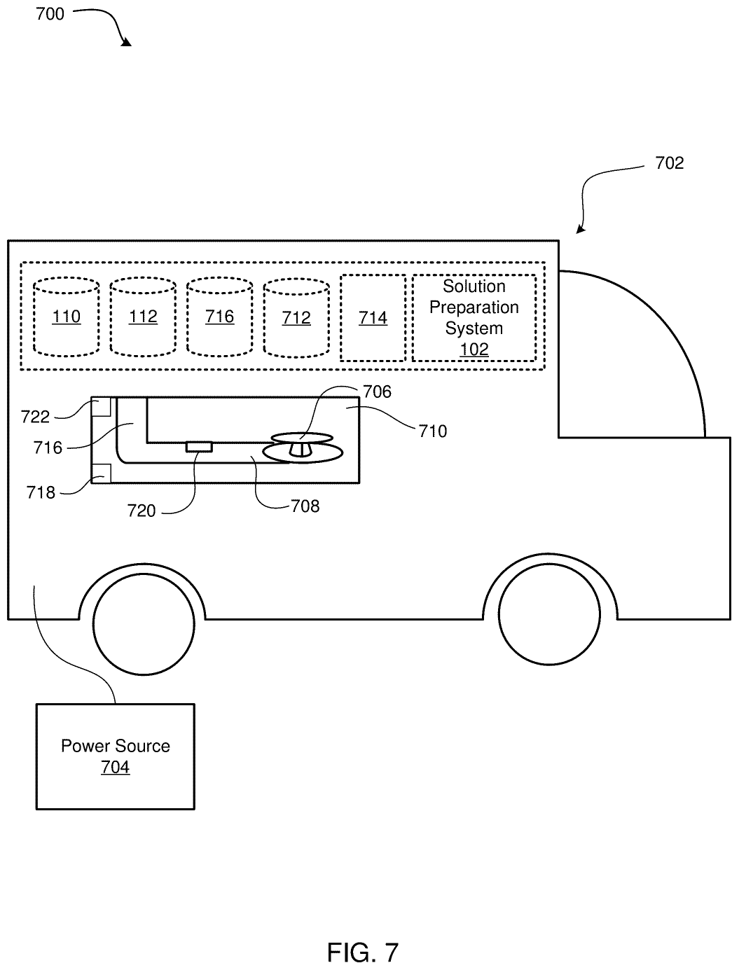

FIG. 7 is a schematic illustration of a straight-on side view of a system 700 for preparing and dispensing frozen confections. The system 700 may be utilized to prepare frozen confections, prepare flavoring syrups for frozen confections, store flavoring syrups for frozen confections, and dispense flavoring syrups for frozen confections. The system 700 may include the system 100 first described in connection with FIG. 1 and may specifically include the solution preparation system 102 for preparing flavoring syrups onsite on as-needed basis.

The system 700 includes a mobile edifice 702, which may specifically include one or more of a van, truck, trolley, kiosk, cart, or other suitable mobile edifice for preparing and dispensing frozen confections. The 700 includes a power source 704 in electrical communication with the mobile edifice 702 itself and/or components within the mobile edifice 702. The power source 704 may comprise a mobile power source such as a generator, battery, solar panels, and so forth. The power source 704 may comprise a non-mobile power source 704, and the mobile edifice 702 or one or more components within the mobile edifice 702 may be plugged into the non-mobile power source 704. The power source 704 may be provided by the mobile edifice 702 itself and may comprise one or more of a battery or engine associated with the mobile edifice 702.

The system 700 includes the solution preparation system 102 in electrical communication with the power source 704. The system 700 may additionally include other components of the system 100 first described in connection with FIG. 1, including the mixing vessel 110 and the secondary vessel 112. The mixing vessel 110 and the secondary vessel 112 may be releasably in fluid communication with the solution preparation system 102. The system 700 may include a solvent 116, which may comprise a stored solvent 116 and/or a fresh source for the solvent 116, such as a freshwater tap.

The system 700 may include one or more primary reservoirs 712 stored within the mobile edifice 702. The system 700 may optionally additionally include one or more secondary reservoirs 716 stored within the mobile edifice 702. The primary reservoirs 712 are in fluid communication with a fluid dispenser 706 that enables consumers to withdraw a fluid from the primary reservoirs 712 on demand. The secondary reservoirs 716 store additional stock of fluids to be withdrawn from the fluid dispenser 706. The secondary reservoirs 716 may be emptied into the primary reservoirs 712 as needed and/or the secondary reservoirs 716 may be connected in fluid communication with the fluid dispenser 706 to serve as primary reservoirs when the original primary reservoirs 712 are empty.

Each of the primary reservoirs 712 and secondary reservoirs 716 may store a flavoring syrup to be utilized in connection with a frozen confection, wherein the flavoring syrup includes a solid component dissolved within a liquid component. The flavoring syrups may include water, sugar, flavoring, and other additives. In some cases, the system 700 may include a primary reservoir 712 and a secondary reservoir 716 for each flavor to be dispensed from the fluid dispenser 706 of the mobile edifice 702. The flavoring syrups stored within the primary reservoirs 712 and/or secondary reservoirs 716 may be mixed with the solution preparation system 102 described herein.

In some cases, the system 700 includes one or more of the mixing vessel 110 or the secondary vessel 112 in addition to the primary reservoir 712 and secondary reservoir 716 as shown in FIG. 7. In such cases, the primary reservoirs 712 and/or the secondary reservoirs 716 may have different size constraints than the mixing vessel 110 and/or the secondary vessel 112. In these cases, a user may utilize the secondary vessel 112 to store a water solvent to prepare flavoring syrups. Additionally, in these cases, the user may utilize the mixing vessel 110 to prepare flavoring syrups with the solution preparation system 102. The user may then transfer the resultant flavoring syrups from the mixing vessel 110 to the primary reservoirs 712 and/or secondary reservoirs 716 as needed.

In other cases, two or more of the mixing vessel 110, secondary vessel 112, primary reservoir 712, and secondary reservoir 716 are interchangeable. In these cases, the mixing vessel 110 may specifically be interchangeable with the primary reservoir 712 and the secondary reservoir 716 such that the same container may be utilized when mixing a flavoring syrup (i.e. a mixing vessel 110), when storing backup stock of a flavoring syrup (i.e., a secondary reservoir 716), or when dispensing a flavoring syrup through the fluid dispenser 704 (i.e., a primary reservoir 712). In these cases, the containers may be sized to enable the differential pressure tube (see 222) and inlet pump tube (see 226) of the solution preparation system 102 to be disposed within the container such that the container may be utilized as a mixing vessel 110. Additionally, the containers may be equipped with a valve enabling the container to be hooked up to the fluid dispenser 704 such that the containers may be utilized as a primary reservoir 712.

The primary and/or secondary reservoirs 712, 716 may be utilized as dispensing and/or storage reservoirs and may additionally be utilized as a mixing vessel and/or secondary vessel to be utilized directly with the solution preparation system 102. This may enable a user to agitate ingredients for a flavoring syrup (see 406 at FIGS. 4A-4B) with the solution preparation system 102 directly within a primary reservoir 712 and/or secondary reservoir 716. This may eliminate the need for the user to transfer a dissolved solution (see 408 at FIG. 4B) from a mixing vessel to a different primary and/or secondary reservoir 712, 716. This may further enable a user to dispense a solvent directly into the primary reservoir 712 and/or secondary reservoir 716, rather than utilizing an additional secondary vessel 112. In these cases, the primary and/or secondary reservoirs 712, 716 may be sized such that they are suitable to be used directly with the solution preparation system 102. In these cases, all reservoirs within the mobile edifice may be interchangeable to be used as a mixing vessel, secondary vessel, primary reservoir, or secondary reservoir as described herein.

The system 700 may include the fluid dispenser 706 mounted to a mounting arm 708 and disposed within an edifice recess 710 of the mobile edifice 702. The fluid dispenser 706 may be in fluid communication with each of the primary reservoirs 712.

The system 700 may include a coolant provider 714 disposed within the mobile edifice 702 and configured to cool solutions stored within the primary and/or secondary reservoirs 712, 716. The coolant provider 714 may comprise a tank containing a type of liquid or gaseous coolant. The coolant may be routed via separate tubing to the primary and/or secondary reservoirs 712, 716 through the mounting arm 708 to the fluid dispenser 706, or to both simultaneously. The coolant tubing (not shown) may interact with tubing from the primary reservoirs 712 to cool and maintain the temperature of the flavoring syrups.

The mobile edifice 702 may be a truck, van, or another vehicle. While a truck is shown in FIG. 7 as an example it is not necessary for the mobile edifice 702 to be a motorized vehicle. The present disclosure may also extend to carts, wagons, hand trucks, or other such vehicles to which a fluid dispenser 706 and arm 708 may be mounted. The present disclosure may additionally extend to kiosks, stands, or other standing structures that could be transported by truck from one location to another.

The arm 708 may be disposed within an edifice recess 710. The mobile edifice recess 710 may comprise an opening extending into the interior of the mobile edifice 702 or may have one or more back and sidewalls defining the edifice recess as a cavity within a sidewall of the mobile edifice 702. Within the mobile edifice recess 710 may be a number of mechanisms, such as a locking mechanism 718, a deployment mechanism 722, or both. The locking mechanism 718 may comprise a button, lever, or comparable means to facilitate locking the mounting arm 708 to a particular position. A mounting arm 708 may be fully disposed within the edifice recess 710 in a stored position, as seen in FIG. 7. The mounting arm 708 may also extend from the edifice recess 710 away from the mobile edifice 702 in a deployed position.

The mounting arm 708 may additionally feature a secondary dispenser 720. The secondary dispenser 720 may comprise a faucet, spigot, nozzle, a hole, or other mechanism configured to dispense a fluid from a source within the mobile edifice 702. The source may be one of the primary reservoirs 712 or a secondary reservoir 716 independent from primary reservoirs 712. In some implementations secondary dispenser 720 may be in fluid communication with secondary reservoir 716 via tubing. In other implementations the secondary dispenser 720 may dispense fluid from within the mounting arm 708, like, for example, water, from melted ice deposited into a chute within the mobile edifice 702. The secondary dispenser 720 may comprise a knob, handle, or other similar means that, when manipulated, permits the secondary dispenser 720 to dispense a fluid, depending on the source. In implementations where the secondary dispenser 720 is a hole, the fluid may continuously run or drip from secondary dispenser 720.

While FIG. 7 shows a single secondary dispenser 720 located centrally on arm 708, it will be appreciated that this disclosure is not limited to any number or positioning of secondary dispensers 720. Depending on the implementation, a mounting arm 708 may feature multiple secondary dispensers 720 located at various positions along a length of a mounting arm 708. In features utilizing multiple mounting arms 708, a user may have one or more secondary dispensers 720 on one or several of the multiple mounting arms 708 located at various positions along any of the mounting arms 708. In other implementations a user may forego a secondary dispenser 720 altogether.

The mounting arm 708 may be mounted to the mobile edifice 702 by a mount 716.

The mount 716 may comprise a ball joint, a linkage, a hinge, or other similar mechanism that permits a user to mount the mounting arm 708 to the mobile edifice 702 while retaining some degree of movement depending on the mount 716 utilized. The mount 716 may retain the mounting arm 708 in a way such that the mounting arm 708 may move between a closed position or open position. In some implementations the mount 716 may be mounted to a sidewall of the mobile edifice, while in other implementations may be mounted to another structure, such as a rack or shelf which may itself be mounted to the mobile edifice. A rack or shelf may or may not be utilized in a situation where a user may desire to use mount 716 to mount a mounting arm 708 to a roof or underside of the mobile edifice 702. In other implementations a user may mount arm 708 via mount 716 to a roof or underside of the mobile edifice 702 directly.

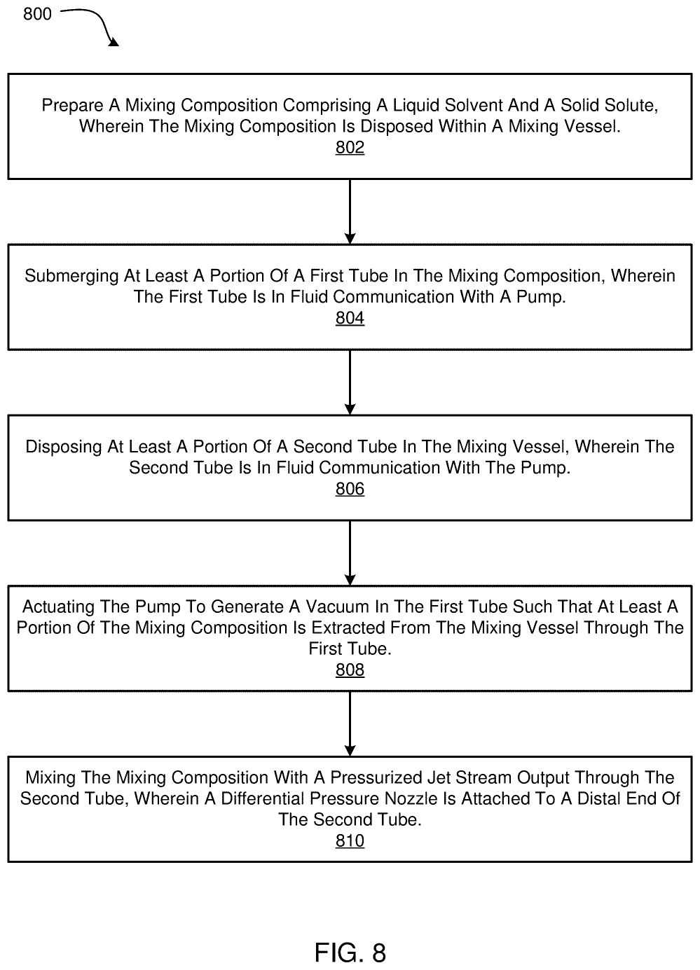

FIG. 8 is a schematic flow chart diagram of a method 800 for mixing a composition. The method 800 includes preparing at 802 a mixing composition comprising a liquid solvent and a solid solute, wherein the mixing composition is disposed within a mixing vessel. The method 800 includes submerging at 804 at least a portion of a first tube in the mixing composition, wherein the first tube is in fluid communication with a pump. The method 800 include disposing at least a portion of a second tube in the mixing vessel, wherein the second tube is in fluid communication with the pump. The method 800 includes actuating at 808 the pump to generate a vacuum in the first tube such that at least a portion of the mixing composition is extracted from the mixing vessel through the first tube. The method 800 includes mixing at 810 the mixing composition with a pressurized jet stream output through the second tube, wherein a differential pressure nozzle is attached to a distal end of the second tube.

### Examples

The following examples pertain to further embodiments.
Example 1 is a system for mixing a solution. The system includes an inlet pump tube configured to be disposed within a mixing vessel. The system includes a pump in fluid communication with the inlet pump tube, wherein the pump extracts a solution from the mixing vessel when the inlet pump tube is disposed within the mixing vessel. The system includes a three-way valve in fluid communication with the pump. The system includes a differential pressure outlet configured to be disposed within the mixing vessel, wherein the differential pressure outlet is in fluid communication with the pump and the three-way valve. The system is such that the extracted solution is processed through the pump and ejected into the mixing vessel through the differential pressure outlet.
Example 2 is a system as in Example 1, wherein the differential pressure outlet comprises: a differential pressure tube attached to the three-way valve and in fluid communication with the pump; and a differential pressure nozzle attached to a distal end of the differential pressure tube and configured to be disposed within mixing vessel.
Example 3 is a system as in any of Examples 1-2, wherein, in response to the pump generating a vacuum to extract the solution from the mixing vessel, the solution passes through the differential pressure tube at a first velocity; wherein the differential pressure nozzle causes the solution to exit the differential pressure nozzle at a second velocity; and wherein the second velocity is faster than the first velocity.
Example 4 is a system as in any of Examples 1-3, wherein the differential pressure nozzle comprises: an inlet comprising an inlet fluid passageway; an outlet comprising an outlet fluid passageway; a converging section comprising a narrow fluid passageway, wherein the narrow fluid passageway comprises a diameter that is smaller than a diameter of the inlet fluid passageway; and a diverging section comprising a widening fluid passageway, wherein the diverging section is disposed in between the converging section and the outlet, and wherein a largest diameter of the widening fluid passageway is greater than the diameter of the narrow fluid passageway.
Example 5 is a system as in any of Examples 1-4, wherein the differential pressure outlet comprises: a differential pressure nozzle; and a differential pressure tube comprising a proximal end and a distal end; wherein the differential pressure nozzle is attached to the differential pressure tube at the distal end of the differential pressure tube; and wherein the differential pressure tube is attached to the three-way valve at the proximal end of the differential pressure tube.
Example 6 is a system as in any of Examples 1-5, wherein the differential pressure outlet comprises a Venturi nozzle.
Example 7 is a system as in any of Examples 1-6, wherein the three-way valve comprises: a first inlet valve port in fluid communication with a fluid source; a second inlet valve port in fluid communication with the pump; and an outlet valve port in fluid communication with the differential pressure outlet.
Example 8 is a system as in any of Examples 1-7, further comprising an inlet configured to be coupled to a pressurized fluid source, wherein the pressurized fluid source outputs a solvent.
Example 9 is a system as in any of Examples 1-8, further comprising a fluid filter and a fluid conditioner, wherein each of the fluid filter and the fluid conditioner is in fluid communication with the inlet such that the solvent output from the pressurized fluid source passes through each of the fluid filter and the fluid conditioner prior to reaching the three-way valve.
Example 10 is a system as in any of Examples 1-9, further comprising a three-way junction, wherein the three-way junction comprises: a junction inlet that receives the solvent output by the pressurized fluid source; a first junction outlet that outputs the solvent to the three-way valve; and a second junction outlet that outputs the solvent to one or more of the mixing vessel or a secondary vessel.
Example 11 is a system as in any of Examples 1-10, further comprising a two-way valve in fluid communication with the second junction outlet, wherein closing of the two-way valve causes the solvent to exit through the first junction outlet and into the three-way valve.
Example 12 is a system as in any of Examples 1-11, further comprising an inlet comprising a hose fitting, wherein the hose fitting is configured to be coupled to a standardized hose in fluid communication with a pressurized fluid source.
Example 13 is a system as in any of Examples 1-12, wherein the solution comprises a liquid solvent and a solid solute, and wherein the mixing of the solution comprises dissolving the solid solute within the liquid solvent.
Example 14 is a system as in any of Examples 1-13, wherein the solution comprises water and sugar.
Example 15 is a system as in any of Examples 1-14, wherein the differential pressure outlet comprises a differential pressure tube and a differential pressure nozzle, and wherein each of the inlet pump tube and the differential pressure tube is configured to be at least partially submerged within the solvent within the mixing vessel.
Example 16 is a system as in any of Examples 1-15, further comprising a housing, wherein the three-way valve is disposed within an interior space defined by the housing, and wherein an external valve switch for opening and closing the three-way valve is attached to an external side of the housing.
Example 17 is a system as in any of Examples 1-16, further comprising a housing, wherein each of the pump and the three-way valve is disposed within an interior space defined by the housing, wherein a proximal end of the inlet pump tube is attached to the pump within the interior space, wherein a distal end of the inlet pump tube is disposed external to the housing, and wherein the inlet pump tube exits the housing through a hole within the housing.
Example 18 is a system as in any of Examples 1-17, further comprising a housing, wherein each of the pump and the three-way valve is disposed within an interior space defined by the housing, wherein a proximal end of the differential pressure outlet is attached to the three-way valve within the interior space, wherein a distal end of the differential pressure outlet is disposed external to the housing, and wherein the differential pressure outlet exits the housing through a hole within the housing.
Example 19 is a system as in any of Examples 1-18, further comprising: a housing, wherein the pump is disposed within the housing; and an actuator in electrical communication with the pump that permits or prevents electricity from passing to the pump; wherein the actuator is attached to the housing such that the actuator is accessible from an exterior of the housing.
Example 20 is a system as in any of Examples 1-19, wherein the pump generates a vacuum in response to the actuator permitting the electricity to pass to the pump.
Example 21 is a system. The system includes a mixing vessel. The system includes a pump system, wherein the pump system includes any of the components or features of any combination of any of Examples 1-20.
Example 22 is a system as in Example 21, wherein the system further includes a secondary vessel.
Example 23 is a system as in any of Examples 21-22, wherein the system further includes a mobile edifice for preparing and/or distributing a frozen confection, and wherein the pump system is disposed within and/or attached to the mobile edifice.

It will be appreciated by those skilled in the art that, while several implementations are described and shown in the exemplary figures herein, one implementation may have any number of features shown. The figures shown herein are intended to be exemplary and non-limiting, and some figures show some features that other figures do not simply for clarity and readability. In other words, it is contemplated that one implementation of the disclosure may feature each and every feature disclosed, or an implementation may feature a subset combination of the features shown without departing from the scope of the disclosure.

In various implementations, a stand for holding or otherwise housing reservoirs and tubes, hoses or lines may be located outside of the mobile edifice. The stand may be a metal stand or made from another material and may be configured to fit inside the mobile edifice for transport to a location.

The foregoing description has been presented for the purposes of illustration and description. It is not intended to be exhaustive or to limit the disclosure to the precise form disclosed. Many modifications and variations are possible in light of the above teaching. Further, it should be noted that any or all of the aforementioned alternate implementations may be used in any combination desired to form additional hybrid implementations of the disclosure.

Further, although specific implementations of the disclosure have been described and illustrated, the disclosure is not to be limited to the specific forms or arrangements of parts so described and illustrated. The scope of the disclosure is to be defined by the claims appended hereto, any future claims submitted here and in different applications, and their equivalents.

In the foregoing Detailed Description, various features of the disclosure are grouped together in a single implementation for the purpose of streamlining the disclosure. This method of disclosure is not to be interpreted as reflecting an intention that the claimed disclosure requires more features than are expressly recited in each claim. Rather, as the following claims reflect, inventive aspects lie in less than all features of a single foregoing disclosed implementation. Thus, the following claims are hereby incorporated into this Detailed Description by this reference, with each claim standing on its own as a separate implementation of the disclosure.

It is to be understood that the above-described arrangements are only illustrative of the application of the principles of the disclosure. Numerous modifications and alternative arrangements may be devised by those skilled in the art without departing from the spirit and scope of the disclosure and the appended claims are intended to cover such modifications and arrangements. Thus, while the disclosure has been shown in the drawings and described above with particularity and detail, it will be apparent to those of ordinary skill in the art that numerous modifications, including, but not limited to, variations in size, materials, shape, form, function and manner of operation, assembly and use may be made without departing from the principles and concepts set forth herein.

Reference throughout this specification to “an example” means that a particular feature, structure, or characteristic described in connection with the example is included in at least one embodiment of the disclosure. Thus, appearances of the phrase “in an example” in various places throughout this specification are not necessarily all referring to the same embodiment.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on its presentation in a common group without indications to the contrary. In addition, various embodiments and examples of the disclosure may be referred to herein along with alternatives for the various components thereof. It is understood that such embodiments, examples, and alternatives are not to be construed as de facto equivalents of one another but are to be considered as separate and autonomous representations of the disclosure.

Although the foregoing has been described in some detail for purposes of clarity, it will be apparent that certain changes and modifications may be made without departing from the principles thereof. It should be noted that there are many alternative ways of implementing both the processes and apparatuses described herein. Accordingly, the present embodiments are to be considered illustrative and not restrictive.

Those having skill in the art will appreciate that many changes may be made to the details of the above-described embodiments without departing from the underlying principles of the disclosure. The scope of the disclosure should, therefore, be determined only by the following claims.

What is claimed is:

1. A system for mixing a solution, the system comprising:
an inlet pump tube configured to be at least partially disposed within a mixing vessel;
a pump in fluid communication with the inlet pump tube, wherein the pump extracts the solution from the mixing vessel when the inlet pump tube is disposed within the mixing vessel;
a three-way valve in fluid communication with the pump; and
a differential pressure outlet configured to be at least partially disposed within the mixing vessel, wherein the differential pressure outlet is in fluid communication with the three-way valve;
wherein the extracted solution is processed through the pump and ejected into the mixing vessel through the differential pressure outlet.

2. The system of claim 1, wherein the differential pressure outlet comprises:
a differential pressure tube attached to the three-way valve and in fluid communication with the pump; and
a differential pressure nozzle attached to a distal end of the differential pressure tube and configured to be disposed within mixing vessel.

3. The system of claim 2, wherein, in response to the pump generating a vacuum to extract the solution from the mixing vessel, the solution passes through the differential pressure tube at a first velocity;
wherein the differential pressure nozzle causes the solution to exit the differential pressure nozzle at a second velocity; and
wherein the second velocity is faster than the first velocity.

4. The system of claim 2, wherein the differential pressure nozzle comprises:
an inlet comprising an inlet fluid passageway;
an outlet comprising an outlet fluid passageway;
a converging section comprising a narrow fluid passageway, wherein the narrow fluid passageway comprises a diameter that is smaller than a diameter of the inlet fluid passageway; and
a diverging section comprising a widening fluid passageway, wherein the diverging section is disposed in between the converging section and the outlet, and wherein a largest diameter of the widening fluid passageway is greater than the diameter of the narrow fluid passageway.

5. The system of claim 1, wherein the differential pressure outlet comprises:
a differential pressure nozzle; and
a differential pressure tube comprising a proximal end and a distal end;
wherein the differential pressure nozzle is attached to the differential pressure tube at the distal end of the differential pressure tube; and
wherein the differential pressure tube is attached to the three-way valve at the proximal end of the differential pressure tube.

6. The system of claim 1, wherein the differential pressure outlet comprises a Venturi nozzle.

7. The system of claim 1, wherein the three-way valve comprises:
a first inlet valve port in fluid communication with a fluid source;
a second inlet valve port in fluid communication with the pump; and
an outlet valve port in fluid communication with the differential pressure outlet.

8. The system of claim 1, further comprising an inlet configured to be coupled to a pressurized fluid source, wherein the pressurized fluid source outputs a solvent.

9. The system of claim 8, further comprising a fluid filter and a fluid conditioner, wherein each of the fluid filter and the fluid conditioner is in fluid communication with the inlet such that the solvent output from the pressurized fluid source passes through each of the fluid filter and the fluid conditioner prior to reaching the three-way valve.

10. The system of claim 8, further comprising a three-way junction, wherein the three-way junction comprises:
a junction inlet that receives the solvent output by the pressurized fluid source;
a first junction outlet that outputs the solvent to the three-way valve; and
a second junction outlet that outputs the solvent to one or more of the mixing vessel or a secondary vessel.

11. The system of claim 10, further comprising a two-way valve in fluid communication with the second junction outlet, wherein closing of the two-way valve causes the solvent to exit through the first junction outlet and into the three-way valve.

12. The system of claim 1, further comprising an inlet comprising a hose fitting, wherein the hose fitting is configured to be coupled to a standardized hose in fluid communication with a pressurized fluid source.

13. The system of claim 1, wherein the solution comprises a liquid solvent and a solid solute, and wherein the mixing of the solution comprises dissolving the solid solute within the liquid solvent.

14. The system of claim 1, wherein the solution comprises water and sugar.

15. The system of claim 1, wherein the differential pressure outlet comprises a differential pressure tube and a differential pressure nozzle, and wherein each of the inlet pump tube and the differential pressure tube is configured to be at least partially submerged within the solvent within the mixing vessel.

16. The system of claim 1, further comprising a housing, wherein the three-way valve is disposed within an interior space defined by the housing, and wherein an external valve switch for opening and closing the three-way valve is attached to an external side of the housing.

17. The system of claim 1, further comprising a housing, wherein each of the pump and the three-way valve is disposed within an interior space defined by the housing, wherein a proximal end of the inlet pump tube is attached to the pump within the interior space, wherein a distal end of the inlet pump tube is disposed external to the housing, and wherein the inlet pump tube exits the housing through a hole within the housing.

18. The system of claim 1, further comprising a housing, wherein each of the pump and the three-way valve is disposed within an interior space defined by the housing, wherein a proximal end of the differential pressure outlet is attached to the three-way valve within the interior space, wherein a distal end of the differential pressure outlet is disposed external to the housing, and wherein the differential pressure outlet exits the housing through a hole within the housing.

19. The system of claim 1, further comprising:
a housing, wherein the pump is disposed within the housing; and
an actuator in electrical communication with the pump that permits or prevents electricity from passing to the pump;
wherein the actuator is attached to the housing such that the actuator is accessible from an exterior of the housing.

20. The system of claim 19, wherein the pump generates a vacuum in response to the actuator permitting the electricity to pass to the pump.
